(19) United States
(12) Patent Application Publication
(10) Pub. No.: US 2009/0287361 A1
(43) Pub. Date: Nov. 19, 2009

(54) Command Input System

(75) Inventors: Makoto Iwashima, Kanagawa-ken (JP); Masaki Hirota, Kanagawa-ken (JP); Yoshimi Ohta, Kanagawa-ken (JP); Yasuhiro Fukuyama, Kanagawa-ken (JP)

Correspondence Address: FOLEY AND LARDNER LLP;SUITE 500, 3000 K STREET NW, WASHINGTON, DC, 20007, US

(73) Assignee: Nissan Motor Co., Ltd

(21) Appl. No.: 11/887,830

(22) PCT Filed: Mar. 16, 2006
(86) PCT No.: PCT/JP2006/305760

§ 371 Date: Oct. 4, 2007

(30) Foreign Application Priority Data
Apr. 5, 2005 (JP) 2005 108802
Jun. 17, 2005 (JP) 2005 178332

(51) Int. Cl. G05D 23/19; H04N 5/33

(52) U.S. Cl. 700/300; 348/164

(57) ABSTRACT

A command input system, includes: 1) an infrared camera for picking up an image of a sensing area, with which defines a certain part as a back face; 2) an extractor for extracting, based on an image data of the image picked up by the infrared camera, at least one of the following: a) a configuration of a hand, and b) a movement of a hand; and 3) a temperature adjustor for adjusting at least one of a hand temperature and a back face temperature so as to increase a difference between the hand temperature and the back face temperature.

### TECHNICAL FIELD

The present invention relates to a command input system for receiving an input of a command which is sent to an on-vehicle computer and is shown by a vehicular occupant. Especially, the present invention relates to the command input system using an infrared camera.

### BACKGROUND ART

Various on-vehicle devices installed on a vehicle have made input operations by a vehicular occupant more complicated. For decreasing load of the vehicular occupant during driving, such an input unit is proposed as recognizes configuration and movement of the driver's finger by an image sensor and receives a command according to the configuration and movement of the driver's finger, where the driver's finger is extended while gripping a steering wheel. For allowing the input unit to recognize the configuration and the like of the driver's finger even at night or in a dark place where an ordinary camera finds difficulty in picking up image, an input unit disclosed in each of Japanese Patent Application Laid-Open No. 2001-216069 (JP2001216069) and Japanese Patent Application Laid-Open No. 2003-131785 (JP2003131785) uses a certain image sensor capable of sensing an infrared ray discharged from an object.

However, depending on season, air temperature and the vehicular occupant's body temperature, a difference in temperature between the driver's hand (sensing object) and the back ground, in other words, a difference in infrared ray quantities therebetween is small, making it impossible to extract the configuration and movement of the driver's hand from the back ground. With this, the command shown by the vehicular occupant is rendered unrecognizable or improperly recognized. In addition, a possible method of forcibly warming up the hand of the vehicular occupant when the temperature is high during such a period as summer discomforts the vehicular occupant, which is inconvenient.

### DISCLOSURE OF THE INVENTION

It is an object of the present invention to provide a command input system and a command input method for improving, without discomforting the vehicular occupant, recognition of command by configuration and the like of a hand of a vehicular occupant.

According to a first aspect of the present invention, there is provided a command input system, comprising: 1) an infrared camera for picking up an image of a sensing area which defines a certain part as a back face; 2) an extractor for extracting, based on an image data of the image picked up by the infrared camera, at least one of the following: a) a configuration of a hand, and b) a movement of a hand; and 3) a temperature adjustor for adjusting at least one of a hand temperature and a back face temperature so as to increase a difference between the hand temperature and the back face temperature.

According to a second aspect of the present invention, there is provided a method of inputting a command, comprising: 1) picking up an image of a sensing area which defines a certain part as a back face; 2) extracting, based on an image data of the image picked up by the infrared camera, at least one of the following: a) a configuration of a hand, and b) a movement of a hand; and 3) adjusting at least one of a hand temperature and a back face temperature so as to increase a difference between the hand temperature and the back face temperature.

According to a third aspect of the present invention, there is provided a command input system, comprising: 1) means for picking up an image of a sensing area which defines a certain part as a back face; 2) means for extracting, based on an image data of the image picked up by the infrared camera, at least one of the following: a) a configuration of a hand, and b) a movement of a hand; and 3) means for adjusting at least one of a hand temperature and a back face temperature so as to increase a difference between the hand temperature and the back face temperature.

Other and further features, advantages and benefits of the present invention will become apparent from the following description in conjunction with the following drawings.

### BRIEF DESCRIPTION OF THE DRAWINGS

FIG. 1 shows an example of using a command input system, according to a first embodiment of the present invention.

FIG. 2 is a block diagram of the command input system, according to the first embodiment.

FIG. 3 shows an example of a sensing area.

FIG. 4 is a flow chart showing steps of controlling the command input system, according to the first embodiment.

FIG. 5 is a block diagram showing the command input system, according to a second embodiment and a third embodiment of the present invention.

FIG. 6 is a flow chart showing steps of controlling the command input system, according to the second embodiment and the third embodiment.

FIG. 7 shows a block diagram of the command input system, according to a fourth embodiment of the present invention.

FIG. 8 shows an example of the sensing area, according to the fourth embodiment.

FIG. 9A and FIG. 9B show a first example of a back heater, according to the fourth embodiment.

FIG. 10A and FIG. 10B show a second example of the back heater, according to the fourth embodiment.

FIG. 11A and FIG. 11B show a third example of the back heater, according to the fourth embodiment.

FIG. 12A and FIG. 12B show a fourth example of the back heater, according to the fourth embodiment.

FIG. 13A and FIG. 13B show a fifth example of the back heater, according to the fourth embodiment.

FIG. 14A and FIG. 14B show a sixth example of the back heater, according to the fourth embodiment.

FIG. 15 is a flow chart showing steps of controlling the back heater, according to the fourth embodiment.

FIG. 16A and FIG. 16B each explain about a method of controlling the back heater, according to the fourth embodiment.

FIG. 17 is a flow chart show steps of controlling an input controller, according to the fourth embodiment.

### BEST MODE FOR CARRYING OUT THE INVENTION

### First Embodiment

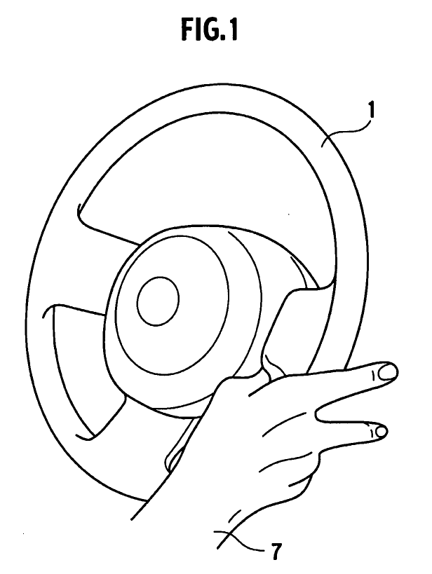

Hereinafter explained referring to the drawings is a command input system 100, according to a first embodiment of the present invention. According to the first embodiment, the command input system 100 is installed on a vehicle. As shown in FIG. 1, a vehicular occupant gripping a steering wheel 1 receives an input of a command expressed by state or movement of the vehicular occupant's hand 7 or finger 71, where the state specifically includes, for example, the number of fingers 71 extended for gripping the steering wheel 1. The command according to the first embodiment is for controlling an on-vehicle system such as audio system, air conditioner, navigation system and the like.

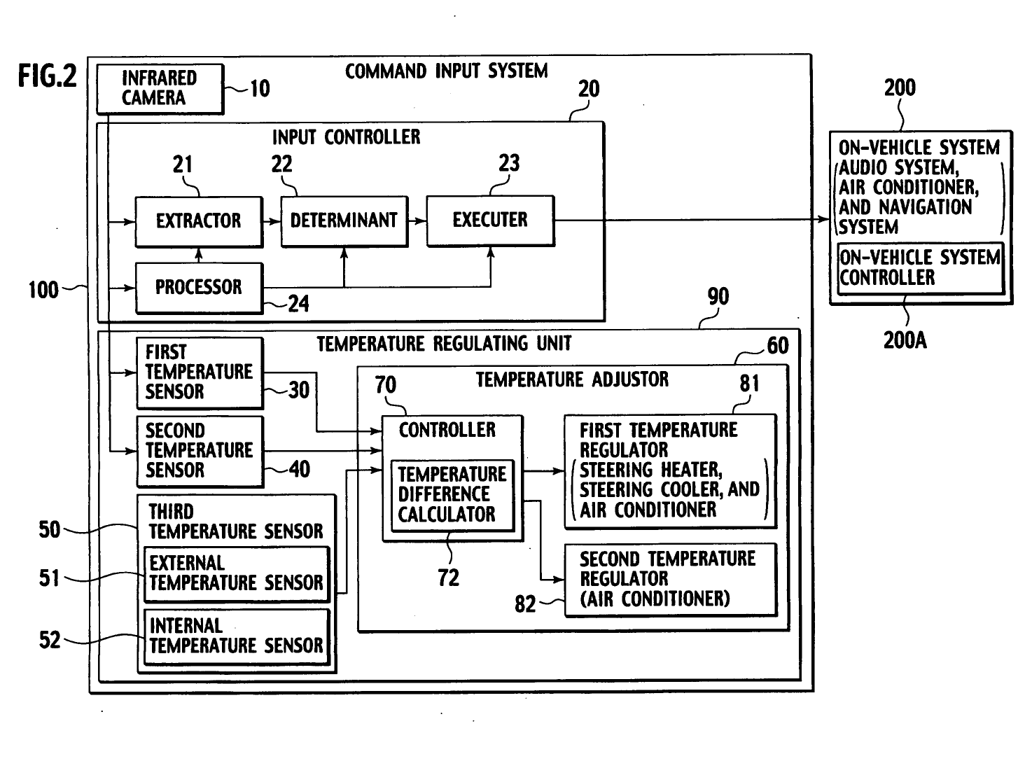

FIG. 2 shows a block diagram of the command input system 100, according to the first embodiment. As shown in FIG. 2, the command input system 100 is provided with an infrared camera 10, an input controller 20 and a temperature regulating unit 90. The command input system 100 is so connected to an external on-vehicle system 200 as to receive information via an on-vehicle LAN.

The command input system 100 sends to the on-vehicle system 200 the command received via the on-vehicle LAN.

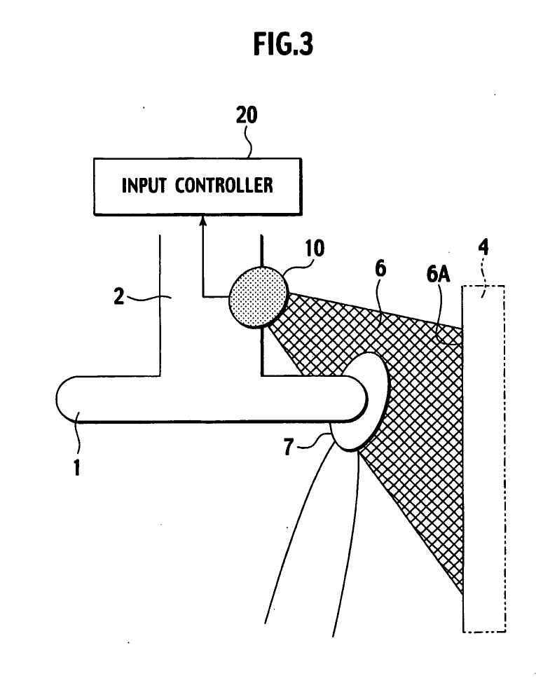

The command input system 100 according to the first embodiment uses the infrared camera 1Q for picking up an image of a command shown by the vehicular occupant, to thereby extract and determine the command based on the thus picked up image data. FIG. 3 shows an example of arranging the infrared camera 10, according to the first embodiment (also according to a second embodiment and a third embodiment to be described afterward). FIG. 3 shows a front view of a sensing area 6, with the hand 7 of the vehicular occupant gripping the steering wheel 1. As shown in FIG. 3, the infrared camera 10 according to the first embodiment is fitted to a steering column 2; picks up the image of the certain sensing area 6 including i) the hand 7 gripping the steering wheel 1 and ii) an inner wall (part of the vehicle) of a front door 4 which wall is a back face 6A; and obtains infrared data of the hand 7 (sensing object) and the back face 6A which are included in the sensing area 6. The sensing area 6 so set as described above is for excluding from the picked-up image data any object other than the hand 7 and the back ground, examples of the any object including a part of the body of the vehicular occupant. With this, it is the back face 6A and the hand 7 (sensing object) that can be picked up, thus precisely extracting the state and the like of the hand 7 shown by the vehicular occupant. Herein, FIG. 3 shows locations of the structural members of the vehicle having the right-hand steering wheel 1, otherwise a vehicle having a left-hand steering wheel 1 has structural members of opposite locations to those in FIG. 3.

As shown in FIG. 2, the input controller 20 is provided with an extractor 21, a determinant 22, an executor 23 and a processor 24; and executes the command by the vehicular occupant based on the image data picked up by the infrared camera 10.

From the image data picked up by the infrared camera 10, the extractor 21 extracts at least one of the hand 7's configuration and the hand 7's movement. Though not specifically limited, an extracting method extracts distribution of temperature points in a temperature zone which is made based on a hand temperature T7 (24° C. to 34° C., skin temperature) of human being, to thereby extract at least one of the hand 7's configuration and the hand 7's movement from the above distribution.

The determinant 22 determines contents of the command based on at least one of the hand 7's configuration and the hand 7's movement which are extracted by the extractor 21. Though not specifically limited, a determining method recognizes the thus extracted at least one of the hand 7's configuration and the hand 7's movement based on a characteristic point (finger tips and the like). The determining method may otherwise be a pattern matching method. According to the first embodiment, comparing i) the at least one of the hand 7's configuration and the hand 7's movement which are thus extracted with ii) the at least one of the hand 7's configuration and the hand 7's movement which are assigned in advance to the command determines the command of the extracted at least one of the hand 7's configuration and the hand 7's movement. From a readable memory (RAM or ROM), the determinant 22 obtains information which correlates in advance i) the command contents with ii) the at least one of the hand 7's configuration and the hand 7's movement. The above information specifies a certain command correlated in advance from the at least one of the hand 7's configuration and the hand 7's movement. The above correlation may be i) a certain configuration (for example, the number of fingers 71) and the like of the hand 7 relative to the command (for example, ON/OFF of the device); or ii) a combination of the certain configuration (for example, the number of fingers 71) and the like of the hand 7 relative to a certain command (for example, sound volume UP/DOWN after selection) in accordance with hierarchy of the command.

The executor 23 executes the command determined by the determinant 22. The executor 23 sends the thus determined command toward the on-vehicle system 200 controlled by the command. Each of the on-vehicle systems 200 receiving the command executes the command.

When a difference T7−T6A between the hand temperature T7 and a back face temperature T6A is less than or equal to a first certain temperature T1 (where the difference T7−T6A is sensed based on the image data picked up by the infrared camera 10), the processor 24 stops the extracting operation (which is based on the picked-up image data) and the operations after the extracting operation, thereafter outputting the above stop information to the vehicular occupant. When the difference T7−T6A between the hand temperature T7 and the back face temperature T6A is less than or equal to the first certain temperature T1 (in other words, insufficient), the processor 24 precisely extracts the command, determining that the determination of the command is of difficulty, to thereby temporarily stop the extracting operation (which uses the picked-up image data) and the operations after the extracting operation. In addition, the processor 24 informs the vehicular occupant about the stop, thereby preventing the vehicular occupant from any unnecessary command input which may be caused by a possible erroneous recognition.

The temperature regulating unit 90 includes a first temperature sensor 30, a second temperature sensor 40, a third temperature sensor 45 and a temperature adjustor 60.

Based on the image data picked up by the infrared camera 10, the first temperature sensor 30 senses the hand temperature T7 (a first sensed temperature T1-S), then sends the hand temperature T7 to a controller 70. The first temperature sensor 30 assumes a block of temperature points of the human skin temperature zone (24° C. to 34° C.) in the picked-up image data as the hand temperature 7 of the vehicular occupant, thereby sensing the temperature of the above part (average temperature, center-part temperature and the like) as the temperature (the first sensed temperature T1-S) of the hand 7 of the vehicular occupant. According to the first embodiment, the sensing area 6 is so set that an image of any human body part other than the hand 7 of the vehicular occupant is not picked up, thereby precisely extracting the picked-up image data (which corresponds to the hand 7) by an easy determining method.

Likewise, based on the image data picked up by the infrared camera 10, the second temperature sensor 40 senses the back face temperature T6A (a second sensed temperature T2-S) of the back face 6A in the sensing area 6, then sends the back face temperature T6A to the controller 70. The second temperature sensor 40 assumes a temperature point other than the human skin temperature zone (24° C. to 34° C.) in the picked-up image data as the back face 6A, thereby sensing the temperature of the above part (average the temperature and the like) as the back face temperature T6A. According to the first embodiment, the sensing area 6 is so set that an image of any part other than the back face 6A and the hand 7 is not picked up. With this, eliminating the extracted hand 7's data from the picked-up image data can extract a picked-up image data of the back face 6A.

The third temperature sensor 45 senses the temperature inside and outside of the vehicle (a third sensed temperature T3-S), and sends the above temperature to the controller 70. The third temperature sensor 45 senses, as the temperature inside and outside of the vehicle (vehicular body, window glass W), a vehicular external temperature Te, a vehicular internal temperature Ti, and a window glass temperature Tw of the vehicle incorporating therein the vehicular occupant. According to the first embodiment, used as the third temperature sensor 45 is a vehicular external temperature sensor 51 for sensing the vehicular external temperature Te around the vehicle incorporating therein the vehicular occupant. Adjusting at least one of the hand temperature T7 and the back face temperature T6A according to the vehicular external temperature Te sensed by the vehicular external temperature sensor 51 can bring about the difference T7−T6A between the hand temperature T7 and the back face temperature T6A without discomforting the vehicular occupant. The vehicular internal temperature sensor 52 sensing the vehicular internal temperature Ti of the vehicle incorporating therein the vehicular occupant can also be used as the third temperature sensor 45. Adjusting at least one of the hand temperature T7 and the back face temperature T6A according to the vehicular internal temperature Ti sensed by the vehicular internal temperature sensor 52 can bring about the difference T7−T6A between the hand temperature T7 and the back face temperature T6A without discomforting the vehicular occupant. In addition, from the viewpoint of cost, it is preferable to use an vehicular external temperature sensor or an vehicular internal temperature sensor of the air conditioner installed on the vehicle.

The temperature adjustor 60 includes the controller 70, a first temperature regulator 81 and a second temperature regulator 82. When the difference T7−T6A between the hand temperature T7 (sensed by the first temperature sensor 30) and the back face temperature T6A (sensed by the second temperature sensor 40) is less than or equal to the first certain temperature T1, the controller 70 controls at least one of the first temperature regulator 81 and the second temperature regulator 82 according to the vehicular external temperature Te or the vehicular internal temperature Ti whichever is sensed by the third temperature sensor 45, so as to increase the difference T7−T6A between the hand temperature T7 and the back face temperature T6A.

Examples of the first temperature regulator 81 include a steering wheel heater, a steering wheel cooler and the air conditioner for adjusting the hand temperature T7, while examples of the second temperature regulator 82 include the air conditioner for adjusting the back face temperature T6A. Following the controlling by the controller 70, the first temperature regulator 81 heats or cools the hand 7, or the second temperature regulator 82 heats or cools the back face 6A, thereby increasing the difference T7−T6A between the hand temperature T7 and the back face temperature T6A.

The controller 70 according to the first embodiment adjusts at least one of the hand temperature T7 and the back face temperature T6A, by the following two methods:

### [First Method]

Described at first is a first method:

When the difference T7−T6A between the hand temperature T7 sensed by the first temperature sensor 30 and the back face temperature T6A sensed by the second temperature sensor 40 is less than or equal to the first certain temperature T1, while the temperature inside and outside of the vehicle sensed by the third temperature sensor 45 (the third sensed temperature T3-S) is less than a second certain temperature T2, the controller 70 according to the first embodiment heats the hand 7 by means of the first temperature regulator 81, that is, the steering wheel heater or the air conditioner (warm air).

The first certain temperature T1 for the temperature control is not specifically limited, and can be set based on whether or not the hand temperature T7 and the back face temperature T6A can be precisely distinguished referring to the image data picked up by the infrared camera 10. According to the first embodiment, the first certain temperature T1 is set to 5° C., which can otherwise be properly set according to the precision of the infrared camera 10. In addition, the second certain temperature T2 is so set that an environment around the vehicular occupant is hot or not hot, or cold or not cold can be determined. The second certain temperature T2 is to be properly determined, according to a sensing object of the third temperature sensor 45. For example, the vehicular external temperature sensor 51 of the third temperature sensor 45 according to the first embodiment senses the vehicular external temperature Te, while the controller 70 compares the thus sensed vehicular external temperature Te with the second certain temperature T2. With this, the second certain temperature T2 is, preferably, to be set to the vehicular external temperature Te at which the vehicular occupant ordinarily feels cold or hot. Likewise, when the vehicular internal temperature sensor 52 of the third temperature sensor 45 senses the vehicular internal temperature T1, the second certain temperature T2 is, preferably, to be set based on the vehicular internal temperature Ti at which the vehicular occupant ordinarily feels cold or hot. Only when the vehicular external temperature Te or the vehicular internal temperature Ti sensed by the third temperature sensor 45 is lower than the second certain temperature T2 and therefore the vehicular occupant feels cold (or not hot), the temperature adjustor 60 according to the first embodiment heats the hand 7. With this, warming up the hand 7 when the vehicular occupant feels hot can be prevented, thus bringing about the difference T7−T6A between the hand 7 and the back face 6A without discomforting the vehicular occupant.

### [Second Method]

Described next is a second method:

When the difference T7−T6A between the hand temperature T7 sensed by the first temperature sensor 30 and the back face temperature T6A sensed by the second temperature sensor 40 is less than or equal to the first certain temperature T1 while the temperature inside and outside of the vehicle sensed by the third temperature sensor 45 (the third sensed temperature T3-S) is more than or equal to a third certain temperature T3, the controller 70 cools the back face 6A by means of the air conditioner (cool wind) which is the second temperature regulator 82. Like the first method, the first certain temperature T1 by the second method is to be set based on whether or not the hand temperature T7 and the back face temperature T6A can be precisely distinguished referring to the image data picked up by the infrared camera 10. The third certain temperature T3 according to the first embodiment is so set that the environment around the vehicular occupant is hot or not hot, or cold or not cold can be determined. The third certain temperature T3 is to be properly determined, according to the sensing object of the third temperature sensor 45. For example, the vehicular external temperature sensor 51 of the third temperature sensor 45 according to the first embodiment senses the vehicular external temperature Te, while the controller 70 compares the thus sensed vehicular external temperature Te with the third certain temperature T3. With this, the third certain temperature T3 is, preferably, to be set based on the vehicular external temperature Te at which the vehicular occupant ordinarily feels cold or hot. Likewise, when the vehicular internal temperature sensor 52 of the third temperature sensor 45 senses the vehicular internal temperature Ti, the third certain temperature T3 is, preferably, to be set based on the vehicular internal temperature Ti at which the vehicular occupant ordinarily feels cold or hot. Herein, the second certain temperature T2 in the first method and the third certain temperature T3 in the second method may be the same with each other.

When the vehicular external temperature Te or the vehicular internal temperature Ti sensed by the third temperature sensor 45 is more than or equal to the third certain temperature T3 while the vehicular occupant feels hot or not cold, the temperature adjustor 60 according to the first embodiment cools the back face 6A. With this, when the vehicular occupant feels hot, the back face 6A is cooled instead of warming up the hand 7, bringing about the certain difference T7−T6A between the hand temperature T7 and the back face temperature T6A, without discomforting the vehicular occupant.

Although not specifically limited, it is preferable that the temperature regulating unit 90 operates prior to operation of the input controller 20, followed by heating of the hand 7 (sensing object) or cooling of the back face 6A, thus bringing about the difference T7−T6A between the hand temperature T7 and the back face 6A. Operating the input controller 20 with the back face 6A heated allows the input controller 20 to precisely extract and determine the command based on the difference T7−T6A which is forcibly brought about between the back face temperature T6A and the hand temperature T7.

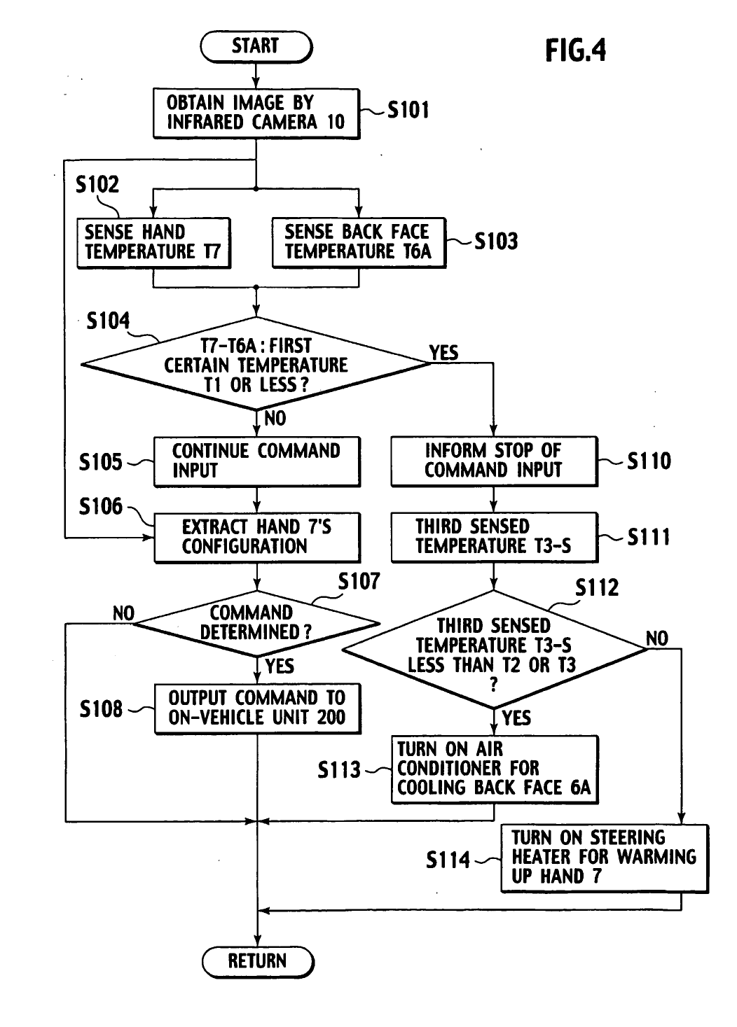

FIG. 4 shows steps of controlling the command input system 100, according to the first embodiment.

(S100) As shown in FIG. 4, after start, the infrared camera 10 picks up the image of the certain sensing area 6 including the hand 7 gripping the steering wheel 1, thereby obtaining the picked-up image data on the temperature distribution.
(S102) Based on the image data picked up by the infrared camera 10, the first temperature sensor 30 senses the hand temperature T7.
(S103) Based on the image data picked up by the infrared camera 10, the second temperature sensor 40 senses the back face temperature T6A in the front door 4 which is the back face 6A.
(S104) A temperature difference calculator 72 (see FIG. 2) of the controller 70 calculates the difference T7−T6A between hand temperature T7 (of the vehicular occupant) and the back face temperature T6A, and determines whether or not the thus calculated difference T7−T6A is less than or equal to the first certain temperature T1.
(S105) With the thus calculated difference T7−T6A more than the first certain temperature T1 (No at S104), the processor 24 continues the command input operations (extracting operation, determining operation, and executing operation).
(S106) Based on the image data picked up by the infrared camera 10, the extractor 21 extracts at least one of the hand 7's configuration and the hand 7's movement.
(S107) The determinant 22 determines whether or not the at least one of the hand 7's configuration and the hand 7's movement thus extracted by the extractor 21 is the command defined in advance.

When Yes at S107, the operation moves to S108.

(S108) To an on-vehicle system controller 200A of the on-vehicle system 200, the executor 23 outputs the command determined by the determinant 22. Based on the thus received command, the on-vehicle system controller 200A controls the on-vehicle system 200.

When the command is not shown, all the flows are ended, thereafter returning to the start.

(S110) Returning to S104, with the calculated difference T7−T6A more than the first certain temperature T1 (Yes at S104), the processor 24 stops the operations (extracting operation, determining operation, and executing operation), thereby outputting the above stop to the vehicular occupant.
(S111) Then, the vehicular external temperature sensor 51 of the third temperature sensor 45 measures the vehicular external temperature Te (the third sensed temperature T3-S), while the vehicular internal temperature sensor 52 of the third temperature sensor 45 measures the vehicular internal temperature Ti (the third sensed temperature T3-S).
(S112) The controller 70 determines whether or not the third sensed temperature T3-S (the vehicular external temperature Te or the vehicular internal temperature Ti) sensed by the third temperature sensor 45 is less than the certain temperature (the second certain temperature T2 or the third certain temperature T3).
(S113) With the vehicular external temperature Te or the vehicular internal temperature Ti being more than or equal to the certain temperature (the second certain temperature T2 or the third certain temperature T3) (Yes at S112), in other words, when the vehicular occupant feels hot or not cold, the controller 70 blows out cool wind from the air conditioner (the second temperature regulator 82) to the back face 6A of the front door 4.
(S114) Meanwhile, with the vehicular external temperature Te or the vehicular internal temperature Ti being less than the certain temperature (the second certain temperature T2 or the third certain temperature T3) (No at S112), in other words, when the vehicular occupant feels cold or not hot, the controller 70 turns on the steering wheel heater which is the first temperature regulator 81. With the first temperature regulator 81 being the air conditioner, warm air is blown from the air conditioner to the hand 7.

Referring to the temperature inside and outside of the vehicle (the third sensed temperature T3-S), the command input system 100 according to the first embodiment forcibly brings about the difference T7−T6A between the hand temperature T7 (sensing object or recognition object) and the back face temperature T6A without discomforting the vehicular occupant, thereby precisely recognizing the command by the hand 7's configuration and the like of the vehicular occupant. In a nutshell, in a cold state such as winter, the command input system 100 according to the first embodiment warms up the hand 7, while in a hot season cools down the back face 6A. Thereby, the effects caused by the season, air temperature, the hand temperature T7 and the like can be eliminated, thus bringing about the certain difference T7−T6A between the hand temperature T7 and the back face temperature T6A without discomforting the vehicular occupant.

### Second Embodiment

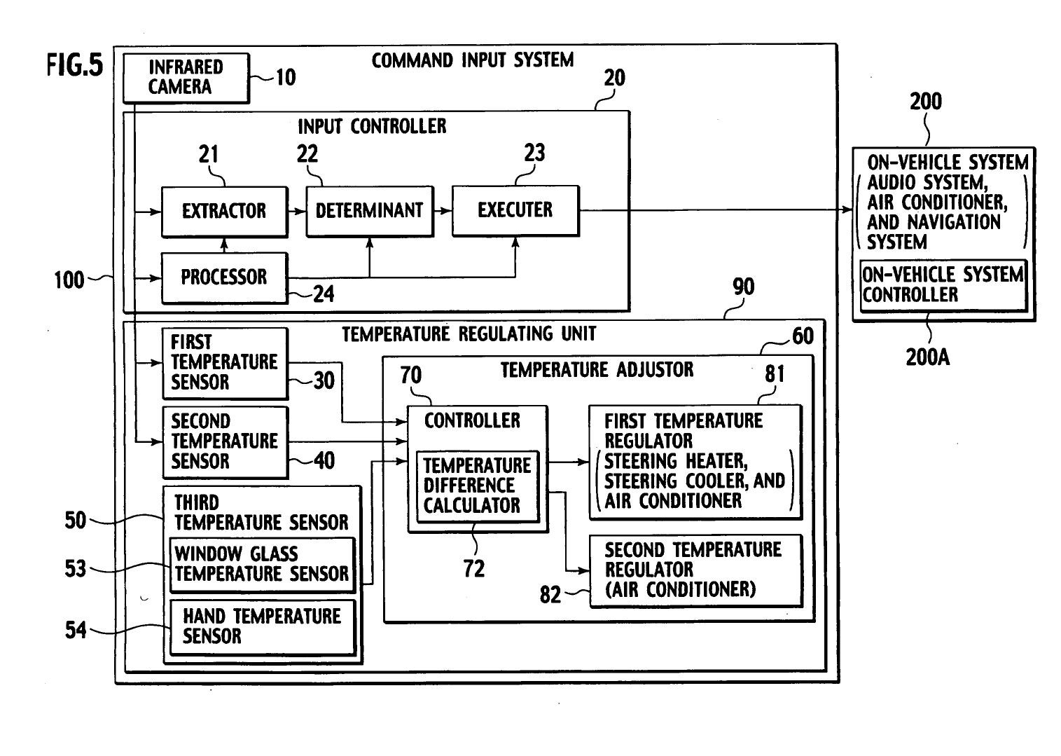

The command input system 100 according to a second embodiment of the present invention, basically, is substantially the same as that according to the first embodiment in terms of structure. The second embodiment is, however, different from the first embodiment in that the method of sensing the third sensed temperature T3-S by the third temperature sensor 45 uses the image data picked up by the infrared camera 10. FIG. 5 shows a block diagram, according to the second embodiment. As shown in FIG. 5, the command input system 100 according to the second embodiment has a window glass temperature sensor 53 for sensing, as the temperature inside and outside of the vehicle, the window glass temperature Tw based on the picked-up image data obtained from the infrared camera 10.

According to the second embodiment, the infrared camera 10 is so set to the steering column 2 that the window glass W is included in the sensing area 6 in addition to the hand 7 and the back face 6A. From the image data picked up by the infrared camera 10, the window glass temperature sensor 53 extracts infrared data of a part of the window glass W which part occupying a certain area of the sensing area 6, thereby sensing a temperature of the part. The window glass W serves as a boundary between the outside and inside of the vehicle, therefore, the window glass temperature Tw is likely to be variable according to the vehicular external temperature Te. The higher the vehicular external temperature Te is, the higher the window glass temperature Tw is, while the lower the vehicular external temperature Te is, the lower the window glass temperature Tw is. According to the second embodiment, the window glass temperature Tw is regarded as the temperature inside and outside of the vehicle (the third sensed temperature T3-S), thereby adjusting at least one of the hand temperature T7 and the back face temperature T6A according to the thus sensed window glass temperature Tw (the third sensed temperature T3-S).

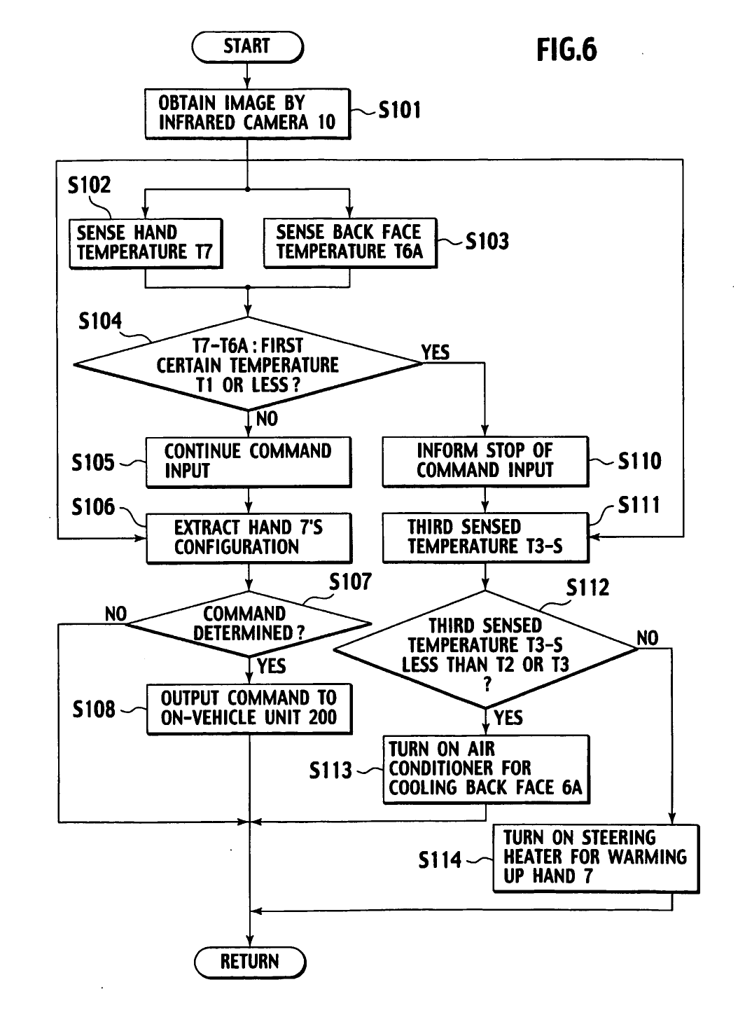

FIG. 6 shows steps of controlling the command input system 100, according to the second embodiment. As shown in FIG. 6, the controlling steps according to the second embodiment are basically the same as those according to the first embodiment in FIG. 4, though having a difference in the flow from S101 to S111. Specifically, the infrared camera 10 in S101 sends the picked-up image data to the third temperature sensor 45. In S111, the third temperature sensor 45 senses the window glass temperature Tw (the third sensed temperature T3-S) based on the picked-up image data.

With this, the second embodiment can sense the third sensed temperature T3-S by commonly-used hardware resources such as the infrared camera 10 and the like, in other words, without the need for providing any new temperature sensor such as the vehicular external temperature sensor 51 and the vehicular internal temperature sensor 52, thereby decreasing cost, an effect brought about in addition to the effect by the first embodiment.

### Third Embodiment

The command input system 100 according to a third embodiment of the present invention, basically, is substantially the same as that according to the first embodiment in terms of structure. The third embodiment is, however, different from the first embodiment in that the method of sensing the third sensed temperature T3-S uses the image data picked up by the infrared camera 10. FIG. 5 shows the block diagram according to the third embodiment (FIG. 5 is used in common between the second embodiment and the third embodiment). As shown in FIG. 5, the command input system 100 according to the third embodiment has a hand temperature sensor 54 for sensing, as the temperature inside and outside of the vehicle, the hand temperature T7 based on the image data picked up by the infrared camera 10. According to the third embodiment, like the first embodiment, the infrared camera 10 is so set to the steering column 2 that the hand 7 and the back face 6A of the front door 4 are included in the sensing area 6 (see FIG. 3). From the image data picked up by the infrared camera 10, the hand temperature sensor 54 extracts infrared data of a part of the hand 7, thereby sensing a temperature of the part. With the operation according to the third embodiment being common with the operation according to the first temperature sensor 30, it is preferable, from the viewpoint of decreasing processing cost, to use the temperature data (the hand temperature T7) sensed by the first temperature sensor 30.

The hand temperature T7 of the vehicular occupant riding on the vehicle is likely to be variable according to the vehicular internal temperature Ti. The higher the vehicular internal temperature Ti is, the higher the hand temperature T7 is, while the lower the vehicular internal temperature Ti is, the lower the hand temperature T7 is. According to the third embodiment, the hand temperature T7 is regarded as the vehicular internal temperature Ti (the third sensed temperature T3-S), thereby adjusting at least one of the hand temperature T7 and the back face temperature T6A according to the thus sensed hand temperature T7 (the third sensed temperature T3-S). Based on the temperature the vehicular occupant actually feels, at least one of the hand temperature T7 and the back face temperature T6A is adjusted, thus causing no discomfort to the vehicular occupant.

FIG. 6 (used in common with the second embodiment) shows controlling steps of the command input system 100, according to the third embodiment. As shown in FIG. 6, the controlling steps according to the third embodiment are basically the same as those according to the first embodiment in FIG. 4, though having a difference in the flow from S101 to S111. Specifically, the infrared camera 10 in S101 sends the picked-up image data to the third temperature sensor 45. In S111, the third temperature sensor 45 senses the third sensed temperature T3-S based on the picked-up image data In this case, the third temperature sensor 45 may obtain the hand temperature T7 sensed in S102 and regard the hand temperature T7 as the third sensed temperature T3-S.

With this, the third embodiment can sense the third sensed temperature T3-S by commonly used-hardware resources such as the infrared camera 10 and the like, in other words, without the need for providing any new temperature sensor such as the vehicular external temperature sensor 51 and the vehicular internal temperature sensor 52, thereby decreasing cost, an effect brought about in addition to the effect by the first embodiment.

### Fourth Embodiment

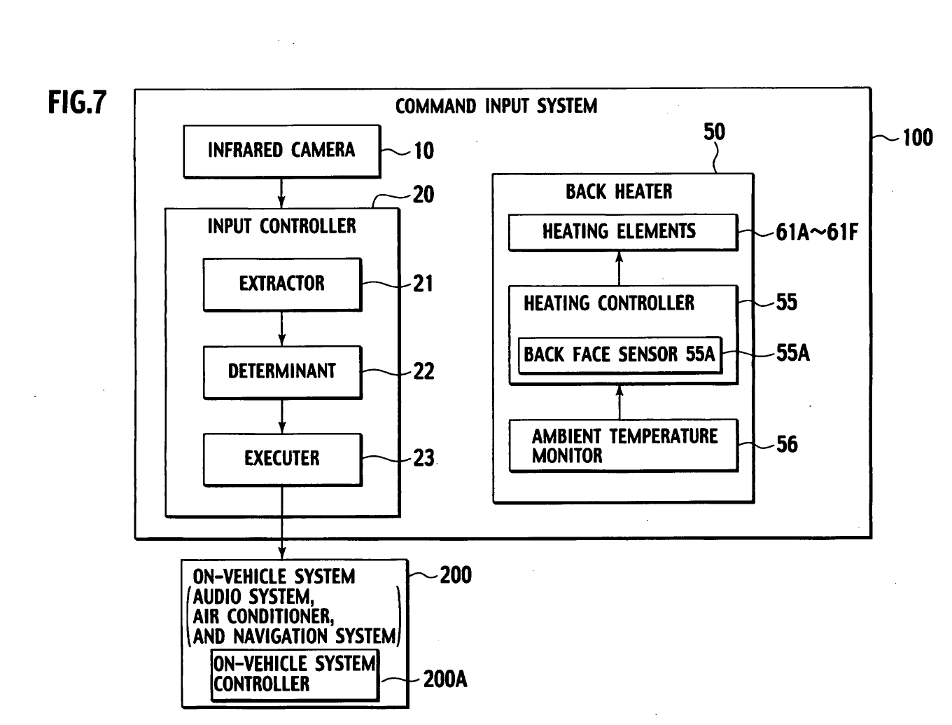

FIG. 7 shows a block diagram of the command input system 100, according to a fourth embodiment. As shown in FIG. 7, the command input system 100 is provided with the infrared camera 10, the input controller 20 and a back heater 50 (otherwise referred to as “temperature adjustor”). The command input system 100 is so connected to the external on-vehicle system 200 as to receive the information via the on-vehicle LAN. The command input system 100 sends to the on-vehicle system 200 the command received via the on-vehicle LAN.

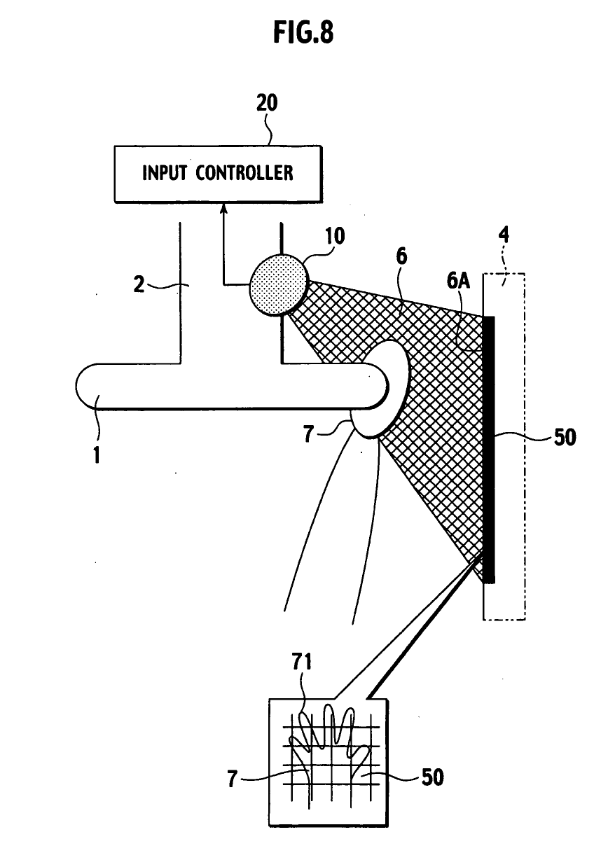

The command input system 100 according to the fourth embodiment uses the infrared camera 10 for picking up the image of the command shown by the vehicular occupant, to thereby extract and determine the command based on the thus picked up image data. FIG. 8 shows an example of arranging the infrared camera 10, according to the fourth embodiment. FIG. 8 shows the front view of the sensing area 6 with the hand 7 of the vehicular occupant gripping the steering wheel 1. As shown in FIG. 8, the infrared camera 10 according to the fourth embodiment is fitted to the steering column 2; picks up the image of the certain sensing area 6 including i) the hand 7 gripping the steering wheel 1 and ii) the inner wall (part of the vehicle) of the front door 4 which is the back face 6A; and obtains the infrared data of the hand 7 (sensing object) and the back face 6A which are included in the sensing area 6. The sensing area 6 so set as described above is for excluding from the picked-up image data any object other than the hand 7 and the back ground, examples of the any object including a part of the body of the vehicular occupant. With this, it is the back face 6A and the hand 7 (sensing object) that can be picked up, thus precisely extracting the state and the like of the hand 7 shown by the vehicular occupant. Herein FIG. 8 shows locations of the structural members of the vehicle having the right-hand steering wheel 1, otherwise a vehicle having a left-hand steering wheel 1 has structural members of opposite locations to those in FIG. 8.

As shown in FIG. 8, according to the fourth embodiment, the back heater 50 is provided for heating the inner wall of the front door 4 which serves as the back face 6A of the sensing area 6 defining the image picked up by the infrared camera 10. The back heater 50 according to the fourth embodiment includes an electric heating element 61 (61A to 61F) embedded in the inner wall of the front door 4 in the sensing area 6 picked up by the infrared camera 10.

In addition, according to the fourth embodiment, the back heater 50 provided with the heating controller 55 for controlling the heat of the heating element 61, heats the back face 6A of the sensing area 6 defining the image picked up by the infrared camera 10, so that the back face temperature T6A can have a temperature higher than a temperature obtained by adding a fourth certain temperature T4 {=minimum temperature resolution (NETD: Noise Equivalent Temperature Difference)} to the vehicular occupant's temperature (body temperature, the hand temperature T7 and the like). Specifically, when the back face temperature T6A measured by a back face sensor 55A is less than the fourth certain temperature T4, the heating controller 55 provided with the back face sensor 55A for sensing the back face temperature T6A heats the back face 6A to the fourth certain temperature T4.

According to the fourth embodiment, the fourth certain temperature T4 is the minimum temperature resolution (NETD: Noise Equivalent Temperature Difference) added by the vehicular occupant's temperature. Herein, the vehicular occupant's temperature can be arbitrarily defined. For example, a preset vehicular occupant's body temperature can be defined as the vehicular occupant's temperature, or a preset hand temperature T7 can be defined as the vehicular occupant's temperature. The vehicular occupant's body temperature or the hand temperature T7 is preferably calculated in advance based on a hand temperature T7 measured through the sufficient number of monitorings, however, may otherwise be defined based on a measured vehicular occupant's temperature who uses the command input system 100. In other words, the vehicular occupant's body temperature or the hand temperature T7 may be measured based on the image data picked up by the infrared camera 10, then the vehicular occupant's temperature may be set based on the thus measured temperature. Herein, the temperature having the minimum temperature resolution NETD is to be preset based on the temperature having the minimum temperature resolution NETD of each of the infrared cameras 10 installed.

Although not specifically limited, preferably, the back heater 50 is provided with an ambient temperature monitor 56 for monitoring a sensing area ambient temperature T6B of the sensing area 6, and the heating controller 55 so controls as to decrease heat quantity (used for heating the back face 6A) with the sensing area ambient temperature T6B lower than a fifth certain temperature T5. With the sensing area ambient temperature T6B being low, the vehicular occupant's temperature (including body temperature, the hand temperature T7) which serves as the sensing object presumably becomes low. According to the decrease in the vehicular occupant's temperature (body temperature; the hand temperature T7), the heat quantity applied to the back face 6A is to be decreased, thereby controlling the heat quantity not to excessively heat the back face 6A. With this, the energy consumed for heating the back face 6A can be saved.

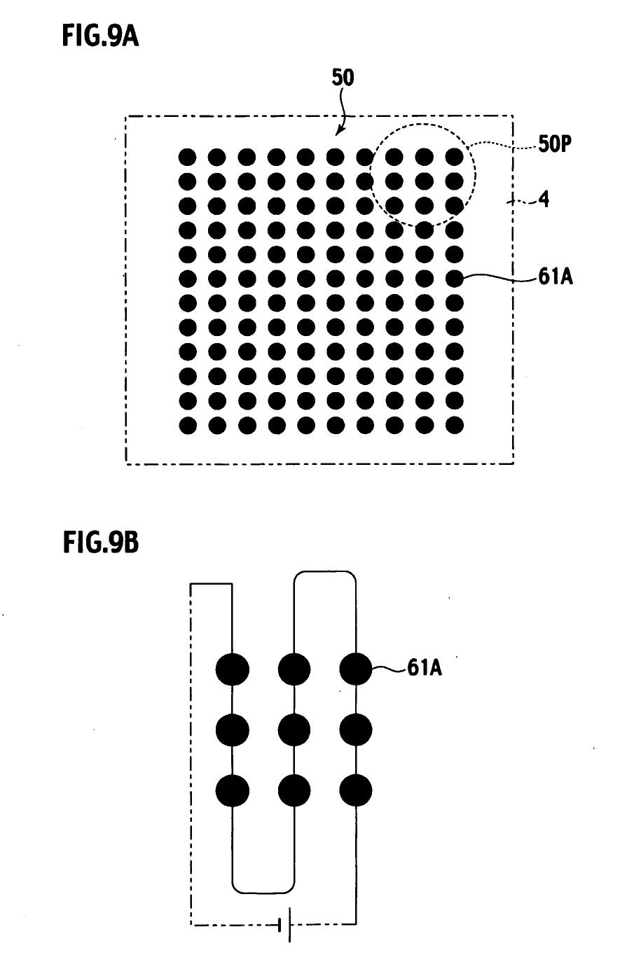

According to the fourth embodiment, being capable of heating the back face 6A of the sensing area 6, the back heater 50 is not specifically limited. FIG. 9 to FIG. 14 show specific examples of the back heater 50.

FIG. 9A shows the back heater 50 having a plurality of the heating elements 61A spotted. The back heater 50 is incorporated in the front door 4 (inner wall). FIG. 9B shows an enlarged view of a part 50P of the back heater 50 in FIG. 9A. The heating elements 61A are electrically connected with each other, thus uniformly heating the back face 6A. With this, the consumed energy can be more saved than heating the entire face.

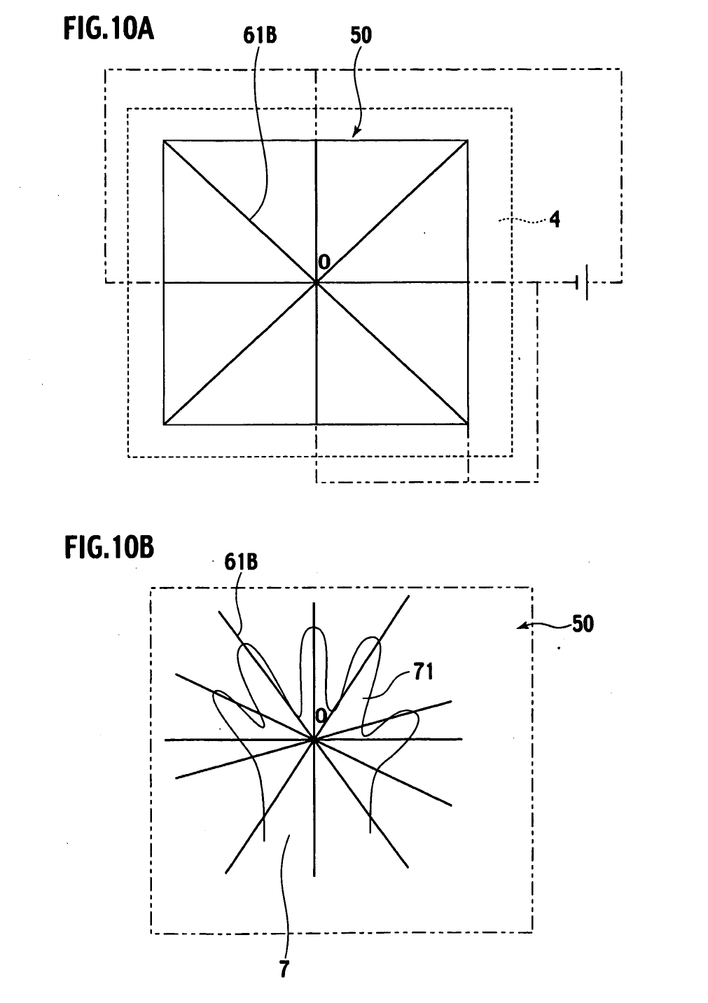

FIG. 10A shows the back heater 50 having the heating elements 61B located radially from a certain point O in the sensing area 6. Although not specifically limited, preferably, the certain point O is to be so positioned in the sensing area 6 as to be set in the center area of the hand 7 defining the image to be picked up. The back heater 50 is incorporated in the front door 4 (inner wall). FIG. 10B shows the image of the hand 7 overlapped with the back heater 50 in FIG. 10A. With the fingers 71 extending radially, the heating elements 61B positioned radially can efficiently heat parts corresponding to the fingers 71 in the back face 6A. With this, the difference T7−T6A can be efficiently brought about between the finger temperature T71 (hand temperature T7) and the back face temperature T6A, thus more saving the consumed energy than heating the entire face.

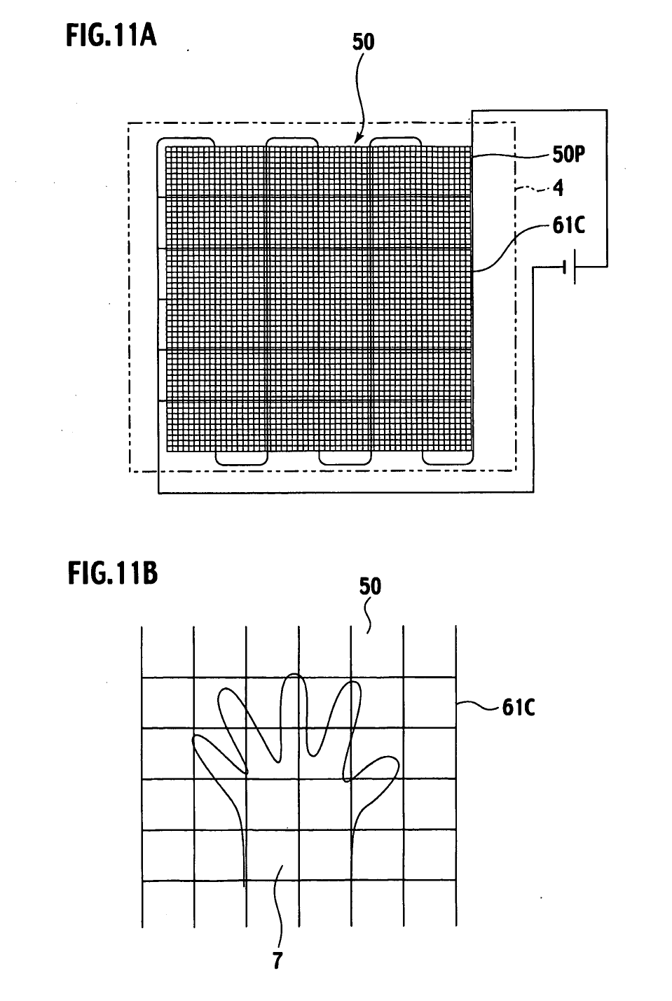

FIG. 11A shows the back heater 50 having the heating elements 61C extending linearly in a form of a mesh. The back heater 50 is incorporated in the front door 4 (inner wall). FIG. 11B shows the image of the hand 7 overlapped with the back heater 50 in FIG. 11A. The heating elements 61C are electrically connected with each other, thus uniformly heating the back face 6A. With this, the consumed energy can be more saved than heating the entire face. In addition, the fingers 71 radially extend in such a manner as to intersect with the heating elements 61C in the form of mesh, thereby determining the hand 7's scale and the finger 71's position based on the position of the heating elements 61C (that is, a position especially heated by the heating element 61C).

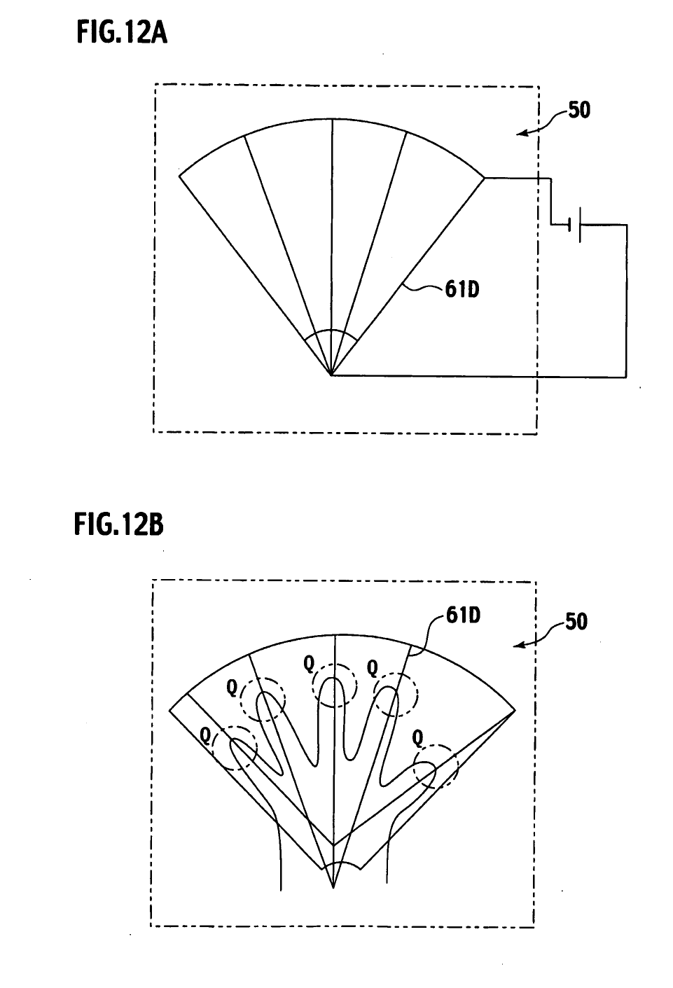

FIG. 12A shows the back heater 50 having heating elements 61D in a form of a sector. The back heater 50 is incorporated in the front door 4 (inner wall). FIG. 12B shows the image of the hand 7 overlapped with the back heater 50 in FIG. 12A. With the fingers 71 extending radially, the heating elements 61D positioned radially can efficiently heat a part corresponding to the finger 71 in the back face 6A. With this, the difference T7−T6A between the finger temperature T71 (hand temperature T7, sensing object) and the back face temperature T6A can be efficiently brought about, thus more saving the consumed energy than heating the entire face. In addition, although not specifically limited, preferably, the heating element 61D is to be so disposed as to pass through a characteristic point Q for extracting the hand 7's configuration and the like. With this, the difference T7−T6A can be efficiently brought about between the characteristic point Q (of the hand 7) and the back face 6A corresponding thereto, thereby precisely recognizing the hand 7's configuration and the like.

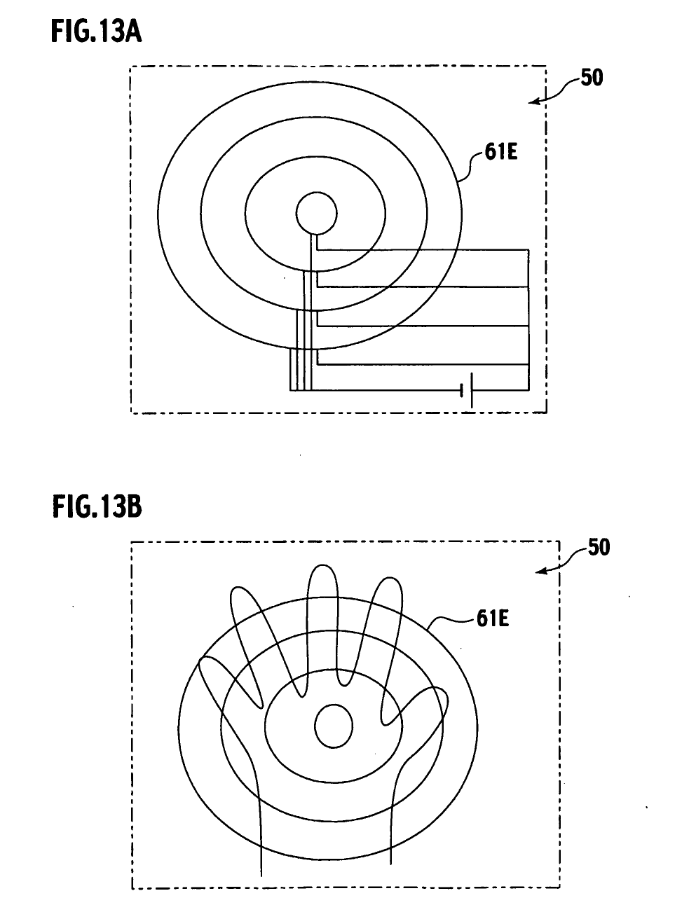

FIG. 13A shows the back heater 50 having the heating elements 61E in a form of concentricity. The back heater 50 is incorporated in the front door 4 (inner wall). FIG. 13B shows the image of the hand 7 overlapped with the back heater 50 in FIG. 13A. The heating elements 61E are electrically connected with each other, heating the back face 6A uniformly. With this, the consumed energy can be more saved than heating the entire face. In addition, ordinarily, the fingers 71 radially extend and intersect with the concentric heating elements 61E, thereby determining the hand 7's scale and the finger 71's position based on the position of the heating elements 61 (that is, a position especially heated by the heating element 61E).

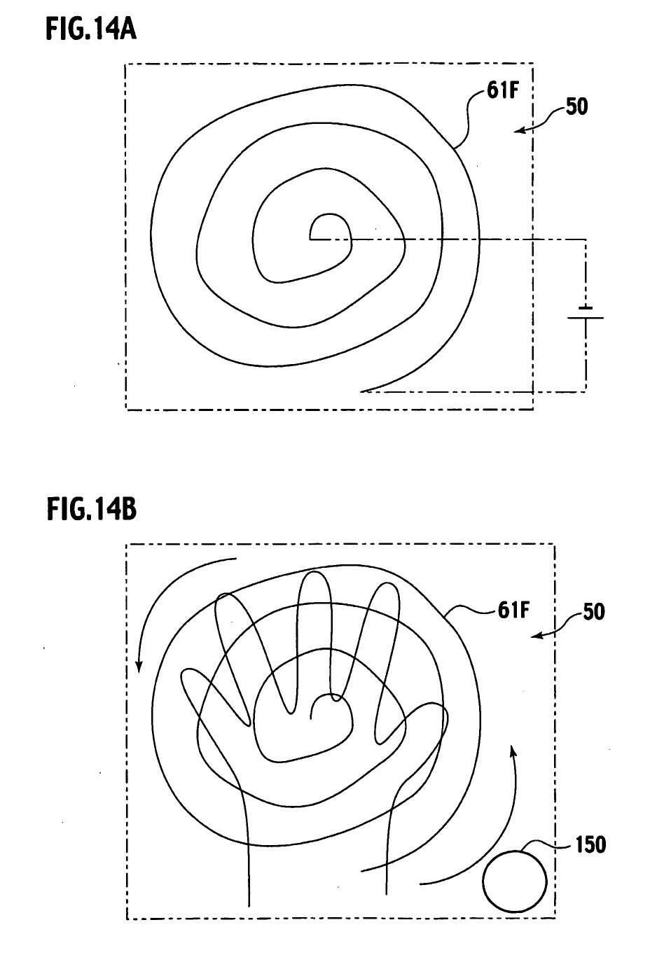

FIG. 14A shows the back heater 50 having the heating element 61F in a form of a spiral. The back heater 50 is incorporated in the front door 4 (inner wall). FIG. 14B shows the image of the hand 7 overlapped with the back heater 50 in FIG. 14A. The heating element 61F is electrically connected, heating the back face 6A uniformly. With this, the consumed energy can be more saved than heating the entire face. In addition, ordinarily, the fingers 71 radially extend and intersect with the spiral heating element 61F, thereby determining the hand 7's scale and the finger 71's position based on the position of the heating element 61 (that is, a position especially heated by the heating element 61F). In addition, the back heater 50 forming one heating element 61F can prevent complicated electrical connection. Although not specifically limited, it is preferable to further provide a rotary mechanism 150 for rotating the heating element 61 in a form of spiral. Rotating the spiral heating element 61F can uniformly heat the entire part of the back face 6A.

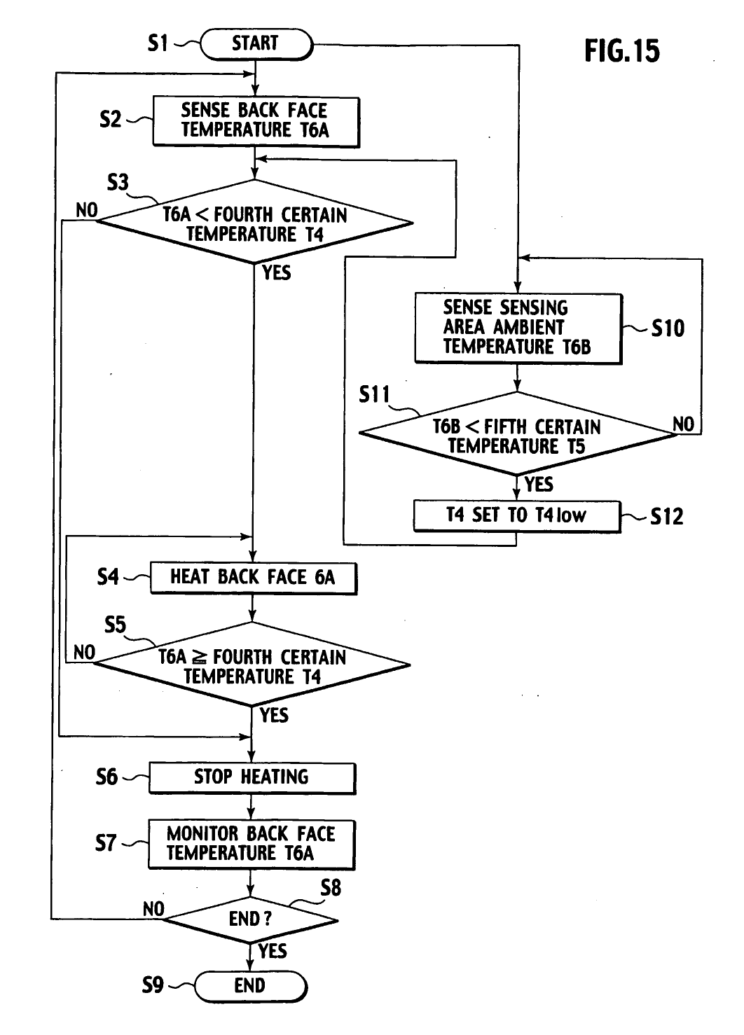

FIG. 15 shows a flow chart for explaining the temperature adjusting operation by the back heater 50 having the above structure, according to the fourth embodiment.

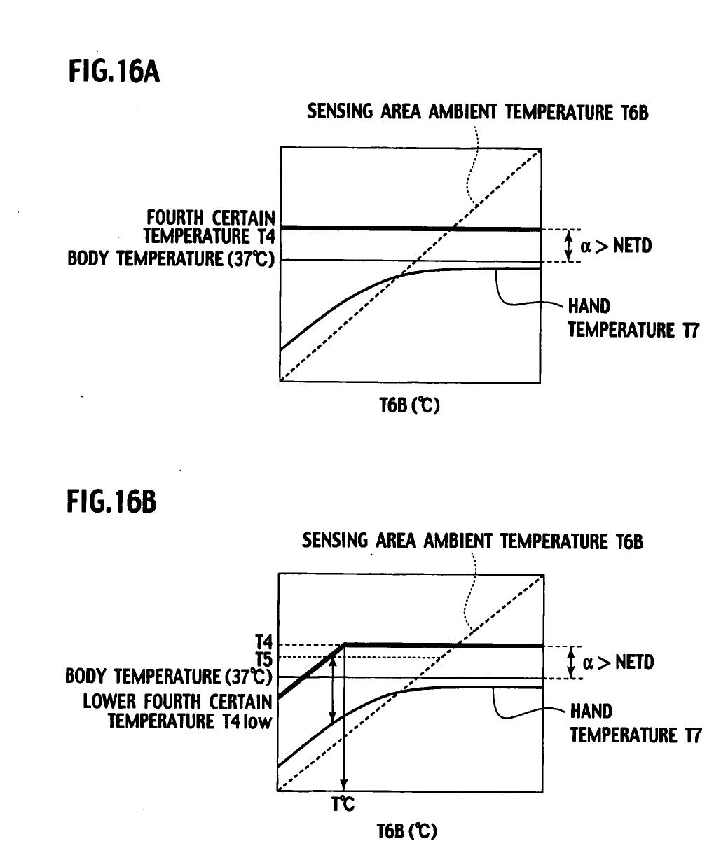

(S1) The operation is started.
(S2) The back face sensor 55A senses the back face temperature T6A of the front door 4 (inner wall) which is the back face 6A of the sensing area 6.
(S3) The process determines whether or not the thus sensed back face temperature T6A is lower than the preset fourth certain temperature T4. Although the method of setting the fourth certain temperature T4 is not specifically limited, as shown in FIG. 16A, the fourth certain temperature T4 is to be defined as a temperature obtained by the body temperature (or the hand temperature T7) 37° C. added by α (more than the minimum temperature resolution NETD).
(S4) With the back face temperature T6A lower than the fourth certain temperature T4 (Yes at S3), the heating controller 55 starts heating the back face 6A.
(S5) After the heating start, the back face sensor 55A senses whether or not the back face temperature T6A is more than or equal to the fourth certain temperature T4. The heating controller 55 heats the back face 6A until the back face temperature T6A becomes more than or equal to the fourth certain temperature T4 (No at S5).
(S6) With the back face temperature T6A becoming more than or equal to the fourth certain temperature T4 (Yes at S5), the heating controller 55 stops heating the back face 6A.
(S7 to S9) The back face sensor 55A continues sensing the back face temperature T6A until an end instruction is inputted.

Although not specifically limited, according to the fourth embodiment, in parallel with step S2 to step S9, step S10 to step S12 are implemented. According to the sensing area ambient temperature T6B (air temperature), step S10 to step S12 decrease the heat quantity used for heating the back face 6A. Herein, for saving the heat quantity used for heating the back face 6A, when the sensing area ambient temperature T6B (air temperature) is less than the fifth certain temperature T5, the fourth certain temperature T4 is to be amended to a lower fourth certain temperature T4low. As shown in FIG. 16B, the decreased air temperature also decreases the body temperature and the hand temperature T7. In other words, with the decreased air temperature, a difference more than or equal to the minimum temperature resolution NETD can be brought about between the back face temperature T6A and the body temperature or the hand temperature T7, without the need for heating the back face 6A to the fourth certain temperature T4. According to the fourth embodiment, with the sensing area ambient temperature T6B lower than the fifth certain temperature T5, the heating controller 55 decreases the fourth certain temperature T4 (that is, the lower fourth certain temperature T4low is used) for heating the back face 6A, to thereby decrease the heat quantity used for heating the back face 6A. Herein, the method of saving the heat quantity is not limited to the above. Specifically, decreasing an output quantity of the back heater 50 by a certain quantity is allowed, or decreasing output time of the back heater 50 by a certain time is allowed.

According to the fourth embodiment, heating the back face 6A to the fourth certain temperature T4 can bring about the difference T7−T6A (more than or equal to the minimum temperature resolution NETD) between the hand temperature T7 (sensing object) and the back face temperature T6A. With this, irrespective of season, air temperature, the body temperature of the vehicular occupant (hand temperature T7), the hand's configuration and the hand's movement can be distinguished from the back ground and can be extracted precisely, based on the image data picked up by the infrared camera 10. Although not specifically limited, preferably, the back heater 50 is to be operated prior to the operation of the input controller 20, thus bringing about the difference T7−T6A (corresponding to the minimum temperature resolution NETD) between the hand temperature T7 (sensing object) and the back face 6A.

With the back face 6A being heated, operating the input controller 20 can precisely extract and determine the command based on the difference T7−T6A brought about between the back face temperature T6A and the hand temperature T7.

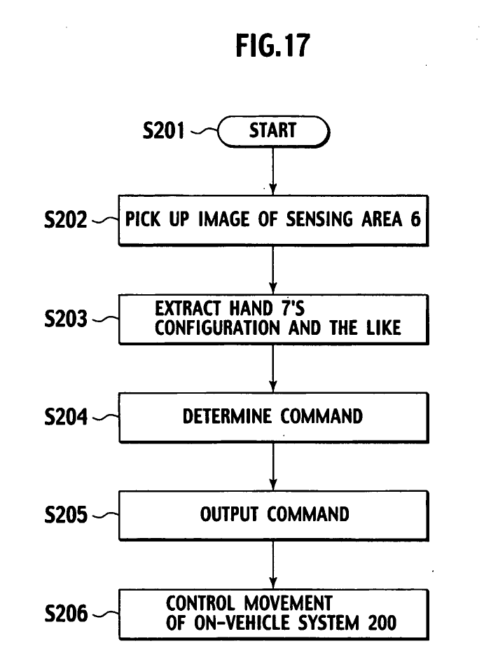

FIG. 17 shows steps of controlling the input controller 20, according to the fourth embodiment.

(S201) The operation is started.
(S202) The infrared camera 10 picks up the image of the certain sensing area 6 including the hand 7 gripping the steering wheel 1.
(S203) Based on the image data picked up by the infrared camera 10, the extractor 21 extracts at least one of the hand 7's configuration and the hand 7's movement.
(S204) The determinant 22 determines contents of the command based on at least one of the hand 7's configuration and the hand 7's movement which are thus extracted by the extractor 21.
(S205) To the on-vehicle system controller 200A, the executor 23 outputs the command determined by the determinant 22. Based on the thus received command, the on-vehicle system 200 controls the on-vehicle system 200.

The entire contents of Japanese Patent Application No. 2005-108802 with its filing date of Apr. 5, 2005 in Japan and Japanese Patent Application No. 2005-178332 with its filing date of Jun. 17, 2005 in Japan are incorporated herein by reference.

Herein, the above explained first embodiment to the fourth embodiment are for explaining the present invention, not limiting the present invention. Therefore, each of the elements disclosed according to the first embodiment to the fourth embodiment may contain various design changes belonging to the technical field under the present invention and may contain equivalents thereof.

### INDUSTRIAL APPLICABILITY

A command input system under the present invention includes: 1) an infrared camera for picking up an image of a sensing area which defines a certain part as a back face; 2) an extractor for extracting, based on an image data of the image picked up by the infrared camera, at least one of the following: a) a configuration of a hand, and b) a movement of a hand; and 3) a temperature adjustor for adjusting at least one of a hand temperature and a back face temperature so as to increase a difference between the hand temperature and the back face temperature. Thereby, the certain difference can be brought about between the hand temperature {of the hand (sensing object)} and the back face temperature without discomforting the vehicular occupant, the effects caused by the season, air temperature, the hand temperature and the like can be eliminated, and command by configuration and the like of the hand can be precisely recognized.

The scope of the present invention is defined with reference to the following claims.

1. A command input system, comprising:
1) an infrared camera for picking up an image of a sensing area which defines a certain part as a back face;
2) an extractor for extracting, based on an image data of the image picked up by the infrared camera, at least one of the following:
a) a configuration of a hand, and
b) a movement of a hand; and
3) a temperature adjustor for adjusting at least one of a hand temperature and a back face temperature so as to increase a difference between the hand temperature and the back face temperature.

2. The command input system as claimed in claim 1, wherein
the command input system further comprises:
1) a first temperature sensor for sensing the hand temperature, based on the image data picked up by the infrared camera,
2) a second temperature sensor for sensing the back face temperature, based on the image data picked up by the infrared camera, and
the temperature adjustor adjusts, in a following state 1, the at least one of the hand temperature and the back face temperature so as to increase the difference between the hand temperature and the back face temperature:
state 1 in which,
the difference between the hand temperature sensed by the first temperature sensor and the back face temperature sensed by the second temperature sensor is equal to or less than a first certain temperature.

3. The command input system as claimed in claim 2, wherein
the command input system further comprises a third temperature sensor for sensing a temperature inside and outside a vehicle, and
the temperature adjustor specifies a part subjected to the adjusting of the at least one of the hand temperature and the back face temperature, according to the temperature inside and outside the vehicle sensed by the third temperature sensor.

4. The command input system as claimed in claim 3, further comprising:
1) a determinant for determining a command corresponding to the at least one of the following extracted by the extractor:
a) the configuration of the hand, and
b) the movement of the hand, and
2) an executor for executing the command determined by the determinant.

5. The command input system as claimed in claim 4, wherein
the temperature adjustor heats the hand of a vehicular occupant, in a following state 2:
state 2 in which,
1) the difference between the hand temperature sensed by the first temperature sensor and the back face temperature sensed by the second temperature sensor is equal to or less the first certain temperature, and
2) the temperature inside and outside the vehicle sensed by the third temperature sensor is less than a second certain temperature.

6. The command input system as claimed in claim 4, wherein
the temperature adjustor cools the back face, in a following state 3:
state 3 in which,
1) the difference between the hand temperature sensed by the first temperature sensor and the back face temperature sensed by the second temperature sensor is equal to or less than the first certain temperature, and
2) the temperature inside and outside the vehicle sensed by the third temperature sensor is more than or equal to a third certain temperature.

7. The command input system as claimed in claim 4, wherein
the third temperature sensor senses a vehicular external temperature of the vehicle on which the vehicular occupant rides.

8. The command input system as claimed in claim 4, wherein
the third temperature sensor senses a vehicular internal temperature of the vehicle on which the vehicular occupant rides.

9. The command input system as claimed in claim 4, wherein
based on the image data picked up by the infrared camera, the third temperature sensor senses a window glass temperature of a window glass of the vehicle on which the vehicular occupant rides.

10. The command input system as claimed in claim 4, wherein
based on the image data picked up by the infrared camera, the third temperature sensor senses the hand temperature of the vehicular occupant.

11. The command input system as claimed in claim 4, further comprising a processor for the following operations:
1) stopping, in a following state 4, the extracting operation by the extractor and the operation after the extracting operation:
state 4 in which,
the difference between the hand temperature and the back face temperature which are sensed based on the image data picked up by the infrared camera is equal to or less than the first certain temperature, and
2) outputting to the vehicular occupant a piece of information on the stopping operation.

12. The command input system as claimed in claim 2, wherein
the temperature adjustor, which is a back heater, heats the back face of the sensing area, to such an extent that the back face has the back face temperature more than a fourth certain temperature which is obtained by the following:
the hand temperature, added by
a minimum temperature resolution of the infrared camera.

13. The command input system as claimed in claim 12, further comprising:
1) a determinant for determining a command corresponding to the at least one of the following extracted by the extractor:
a) the configuration of the hand, and
b) the movement of the hand, and
2) an executor for executing the command determined by the determinant.

14. The command input system as claimed in claim 13, wherein
the back heater has a plurality of spotted heating elements.

15. The command input system as claimed in claim 13, wherein
the back heater has heating elements radially disposed from a certain point in the sensing area.

16. The command input system as claimed in claim 13, wherein
the back heater has heating elements disposed in a form of a mesh.

17. The command input system as claimed in claim 13, wherein
the back heater has heating elements disposed in a form of a sector.

18. The command input system as claimed in claim 17, wherein
the heating elements each are so disposed as to pass through a characteristic point which is used when the extractor extracts the configuration of the hand.

19. The command input system as claimed in claim 13, wherein
the back heater has heating elements disposed in a form of a concentricity.

20. The command input system as claimed in claim 13, wherein
the back heater has a heating element disposed in a form of a spiral.

21. The command input system as claimed in claim 20, wherein
the back heater further has a rotary mechanism for rotating the heating element in the form of the spiral.

22. The command input system as claimed in claim 13, wherein
the back heater senses a sensing area ambient temperature of the sensing area, and
with the thus sensed sensing area ambient temperature less than a fifth certain temperature, the back heater decreases a heat quantity used for heating the back face.

23. A method of inputting a command, comprising:
1) picking up an image of a sensing area which defines a certain part as a back face;
2) extracting, based on an image data of the image picked up by the infrared camera, at least one of the following:
a) a configuration of a hand, and
b) a movement of a hand; and
3) adjusting at least one of a hand temperature and a back face temperature so as to increase a difference between the hand temperature and the back face temperature.

24. A command input system, comprising:
1) means for picking up an image of a sensing area which defines a certain part as a back face;
2) means for extracting, based on an image data of the image picked up by the infrared camera, at least one of the following:
a) a configuration of a hand, and
b) a movement of a hand; and
3) means for adjusting at least one of a hand temperature and a back face temperature so as to increase a difference between the hand temperature and the back face temperature.
